(19) United States
(12) Patent Application Publication
(10) Pub. No.: US 2025/0237630 A1
(43) Pub. Date: Jul. 24, 2025

(54) Monolithic Gas Chromatograph

(71) Applicant: The Regents of The University of Michigan, Ann Arbor, MI (US)

(72) Inventors: Xudong FAN, Ann Arbor, MI (US); Xiaheng HUANG, Ann Arbor, MI (US); Shuo YANG, Farmington Hills, MI (US); Wencheng LI, Ann Arbor, MI (US); Robert NIDETZ, Birmingham, AL (US); Ruchi SHARMA, Ann Arbor, MI (US); Anjali Devi SIVAKUMAR, Ann Arbor, MI (US); Chandrakalavathi THOTA, Ann Arbor, MI (US); Hongbo ZHU, Johnson City, TN (US); Weishu WU, Ann Arbor, MI (US); Seong-Yong JEONG, Ann Arbor, MI (US)

(73) Assignee: The Regents of The University of Michigan, Ann Arbor, MI (US)

(21) Appl. No.: 19/019,942

(22) Filed: Jan. 14, 2025

Related U.S. Application Data
(60) Provisional application No. 63/622,741, filed on Jan. 19, 2024.

(51) Int. Cl. G01N 30/74; G01N 30/02; G01N 30/46

(52) U.S. Cl. CPC G01N 30/74; G01N 30/461; G01N 2030/025

(57) ABSTRACT

A monolithic gas chromatograph is presented. The monolithic gas chromatograph includes a separation column and a gas detector. The separation column has an inlet to receive a gas sample therein. The separation column resides in a first layer of an integrated chip. The gas detector has an ionization chamber and an ionization source. The ionization chamber has an inlet in fluid communication with an outlet of the separation column to receive a gas sample from the separation column. The ionization source is configured to ionize molecules of the gas sample residing in the ionization chamber. The gas detector resides in a second layer of the integrated chip. The monolithic gas chromatograph further includes a third layer disposed between the first layer and the second layer. The third layer is configured to electrically isolate the first layer from the second layer. The gas detector is fluidly coupled to the separation column.

### CROSS-REFERENCE TO RELATED APPLICATIONS

This application claims the benefit and priority of U.S. Provisional Application No. 63/622,741 filed on Jan. 19, 2024. The entire disclosure of the above application is incorporated herein by reference.

### GOVERNMENT CLAUSE

This invention was made with government support under RO1 OH011082 awarded by the Centers for Disease Control and Prevention and FA8650-19-C-9101 awarded by the Air Force Research Laboratory. The government has certain rights in the invention.

### FIELD

The present disclosure relates to monolithic gas chromatographs including a separation column and gas detector on an integrated chip.

### BACKGROUND

In general, gas chromatography systems separate and analyze components of a gas sample including volatile organic compounds (VOCs), such as by identifying components and relative concentrations of analytes in the gas sample. Gas chromatography systems typically include a separation column and a gas detector.

Lab-on-a-chip microfabricated gas chromatography (μGC) has revolutionized the analysis of VOCs by enabling compact, low-power, and rapid analysis in diverse field applications (e.g., environmental monitoring, biomedical diagnosis, homeland security and space exploration). To date, the majority of μGC devices rely on a hybrid integration approach in which individual components (i.e., pre-concentrators, columns, and gas detectors, etc.) are fluidically connected using off-chip interconnects. Although this approach offers advantages such as eliminating thermal crosstalk between components that usually operate at different temperatures and providing greater freedom to optimize and change individual components, it also poses several challenges.

First, manual assembly of a hybrid integrated μGC is labor-intensive, costly, and susceptible to human errors, making it incompatible with mass production. Second, fluidic interfacing methods commonly used in hybrid integration (e.g., epoxy, metal fittings and manifolds, etc.) can either introduce mechanically weak points at the connecting junctions or significantly increase the footprint of presumably miniaturized components. Finally, the hybrid configuration can generate cold spots and dead volumes between transfer lines, thereby causing band broadening and degrading overall chromatographic separation ability of μGC. Consequently, it is advantageous to have a gas chromatography system that monolithically integrates separation micro-columns (μcolumns) and respective gas detectors on a single integrated chip.

Various types of gas detectors, including thermal conductivity detectors (TCD), optical interferometric sensors, pivot plate resonators, photoionization detectors (PID) have been integrated monolithically with Pcolumns owing to their microfabrication compatibility. Among these integrated detectors, PIDs have emerged superior due to their fast response, high sensitivity, and ability to detect a broad range of chemical compounds. Recently, μGC integrated with a micro helium discharge photoionization detector (μDPID) showed rapid separation and detection of alkanes and aromatics with a detection limit of 10. However, the μDPID requires a separate high-purity helium cartridge as an auxiliary flow during operation, which inevitably increases the footprint and weight of the entire system, and requires constant maintenance for cartridge replacement, thus restricting certain field applications.

It is advantageous to reduce the μGC system's footprint by eliminating any carrier gas cartridges. Vacuum ultraviolet (VUV) lamp based PIDs avoid the need for bulky helium cartridges. Although the lower VUV photon energies generated from the VUV lamp (10.6 eV for Kryton lamps and 11.7 eV for Argon lamps) may limit the range of detectable chemical compounds, they allow for the use of ambient air (after removal of hydrocarbons and drying) as the carrier gas without interfering with analysis of target compounds since oxygen and nitrogen ionization potentials are higher than 11.7 eV. Finally, the plasma in lamp-based PIDs is confined inside the lamp and not in direct contact with the electrodes (as in the case of μDPID), which prevents the potential degradation of the electrodes (both excitation and sensing electrodes) exposed to plasma over time.

Conventional gas detectors using VUV lamps are still relatively bulky, and their configuration is not designed for μGC integration. Zhu et al. and Li et al. developed a lamp-based microfluidic PID (μPID) with rapid response and high sensitivity. This pPID was fabricated on a silicon wafer using etched parallel silicon channel walls as the electrodes on a glass substrate. A lamp-based PID (arrayed integrated photoionization detector, AiPD) using co-planar electrodes has also been explored in an attempt for integration with μcolumns. However, fully monolithically integrating the PID and μcolumn still faces some challenges.

In the μDPID-μcolumn work the microfabrication process for monolithically integrating the μDPID and μcolumn, although relatively simple (i.e., a two-mask process), was yet not amicable for wafer-scale batch production due to the need for dicing the silicon and glass wafers into separate individual pieces before anodic bonding (in order to expose the excitation/sensing electrodes for packaging) and the simplified process disallowed an on-chip heater conventionally integrated on μcolumns. Similarly, the AiPD-μcolumn device currently was only realized by manually gluing individually microfabricated dies on a larger substrate using epoxy, which may hinder large-scale manufacturing. Furthermore, coplanar electrodes as in both μDPID and AiPD, while relatively simple to fabricate, would result in non-uniform electric fields that may lead to a sublinear response to analyte concentrations.

It is advantageous to develop an integrated μGC architecture based on a silicon-on-insulator (SOI) structure that enables monolithic integration of a gas detector and a separation column with an embedded on-chip heater. It is also advantageous to develop an integrated μGC that fluidly connects a gas detector and a separation column while maintaining electrical isolation between the gas detector and separation column.

This section provides background information related to the present disclosure which is not necessarily prior art.

### SUMMARY

This section provides a general summary of the disclosure, and is not a comprehensive disclosure of its full scope or all of its features.

In one aspect, a monolithic gas chromatograph includes a separation column and a gas detector on an integrated chip. The separation column has an inlet to receive a gas sample therein. The separation column resides in a first layer of an integrated chip. The gas detector has an ionization chamber and an ionization source. The ionization chamber has an inlet in fluid communication with an outlet of the separation column to receive a gas sample from the separation column. The ionization source is configured to ionize molecules of the gas sample residing in the ionization chamber. The gas detector resides in a second layer of the integrated chip. The monolithic gas chromatograph further includes a third layer disposed between the first layer and the second layer. The third layer is configured to electrically isolate the first layer from the second layer. The gas detector is fluidly coupled to the separation column.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a schematic of an example embodiment of a monolithic gas chromatograph;

FIG. 1B is a schematic cross-section of the monolithic gas chromatograph of FIG. 1A;

FIG. 1C is another schematic of the example embodiment of the monolithic gas chromatograph;

FIG. 2A is an scanning electron microscope (SEM) image of a cross-section of an example embodiment of a monolithic gas chromatograph;

FIG. 2B is photograph of an example embodiment of a pair of electrodes of the monolithic gas chromatograph;

FIGS. 3A-3K illustrate an example fabrication method for the monolithic gas chromatograph;

FIG. 4 illustrates an example method of coating a separation column of the monolithic gas chromatograph;

FIG. 5A is a diagram showing an experimental setup for a monolithic gas chromatograph;

FIGS. 5B-5C are graphs showing test results of the monolithic gas chromatograph;

FIG. 6A is a schematic of the monolithic gas chromatograph showing different regions.

FIGS. 6B and 6C are graphs showing test results of the monolithic gas chromatograph;

FIG. 7A is a diagram showing another experimental setup for a monolithic gas chromatograph;

FIG. 7B is a chromatograph showing test results of the monolithic gas chromatograph; and

FIGS. 8A and 8B illustrate an example system including a monolithic gas chromatograph.

Corresponding reference numerals indicate corresponding parts throughout the several views of the drawings.

### DETAILED DESCRIPTION

Example embodiments will now be described more fully with reference to the accompanying drawings.

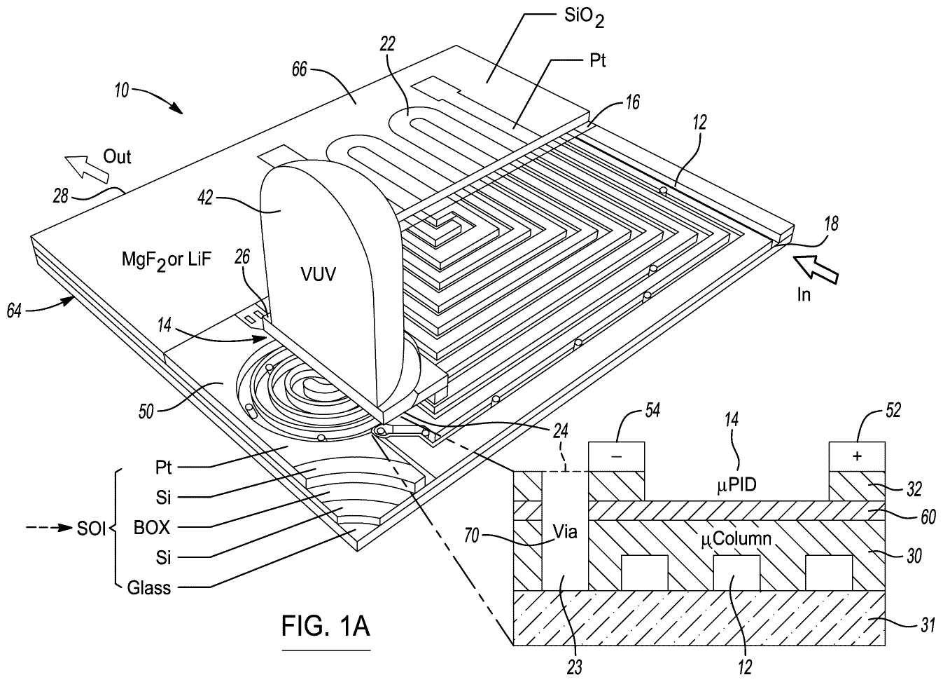

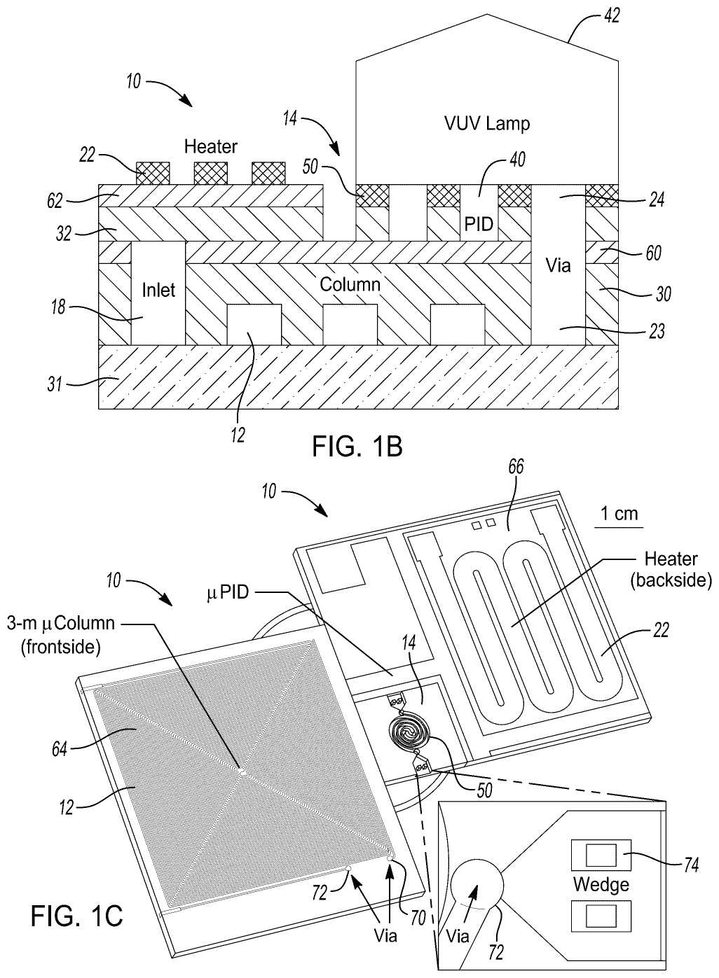

FIGS. 1A-1C illustrate an example embodiment of a monolithic gas chromatograph 10 in accordance with this disclosure. The monolithic gas chromatograph 10 is a microfabricated gas chromatograph. The monolithic gas chromatograph 10 includes a separation column 12 (e.g., a μcolumn) and a gas detector 14 (e.g., a micro gas detector) on an integrated chip 16 (e.g., an integrated circuit).

The separation column 12 includes an inlet 18 to receive a gas sample (not shown) therein. During operation, the gas sample enters the separation column 12 at the inlet 18, is heated via a heater 22, and is subsequently separated as the gas sample flows through the separation column 12. The separation column includes a first intermediate port 23 (FIGS. 1A and 1B) in fluid communication with an inlet 24 of the gas detector 14. The gas sample enters the gas detector 14 at the inlet 24. After the gas sample is detected by the gas detector 14, the gas sample flows to an outlet 26 of the gas detector 14 which is fluidly connected to a second intermediate port (not shown) of the separation column 12. The gas sample then exits the monolithic gas chromatograph 10 at an outlet 28 of the separation column 12. The separation column 12 resides in a first layer 30 of the integrated chip 16. The first layer 30 may be disposed on or bonded (e.g., anodically bonded) to a substrate 31 (e.g., a glass substrate) to seal the separation column 12 from ambient air.

The gas detector 14 resides in a second layer 32 of the integrated chip 16. The gas detector 14 includes an ionization chamber 40 (FIG. 1B) and an ionization source 42. It is to be understood that only the relevant components of the gas detector 14 are discussed in relation to FIGS. 1A-1C, but that other components may be needed to control and manage the overall operation of the system.

The gas detector 14 is an ion-based gas detector that is configured to detect individual gas specifies in the gas sample. In an ion-based gas detector, when the gas sample travels through the gas detector 14, molecules of the gas sample are ionized (e.g., into positive/negative ions and electrons) and are detected for analyte qualification. The ionization source 42 is configured to ionize molecules of the gas sample residing in the ionization chamber 40. In the example embodiment of FIGS. 1A-1C, the gas detector 14 is a photoionization detector (PID) (e.g., a μPID) and the ionization source 42 is a vacuum UV (VUV) light (˜70 nm-200 nm in wavelength) (Krypton for 10.6 eV or Argon for 11.7 eV). The VUV light may be hermetically mounted on the gas detector 14. In other embodiments, the ionization source 42 includes flame (e.g., flame ionization), radioactive materials (e.g., Nickel-63 that emits beta radiation), high-voltage discharge (e.g., corona ionization), high energy (e.g., 70 eV) electrons (e.g., electron impact ionization), and charged molecules (e.g., proton transfer ionization). Flame ionization detector (FID), electron capture detector (ECD), Faraday cup-based detector, and electron multiplier tube (EMT) may also be suitable gas detectors 14.

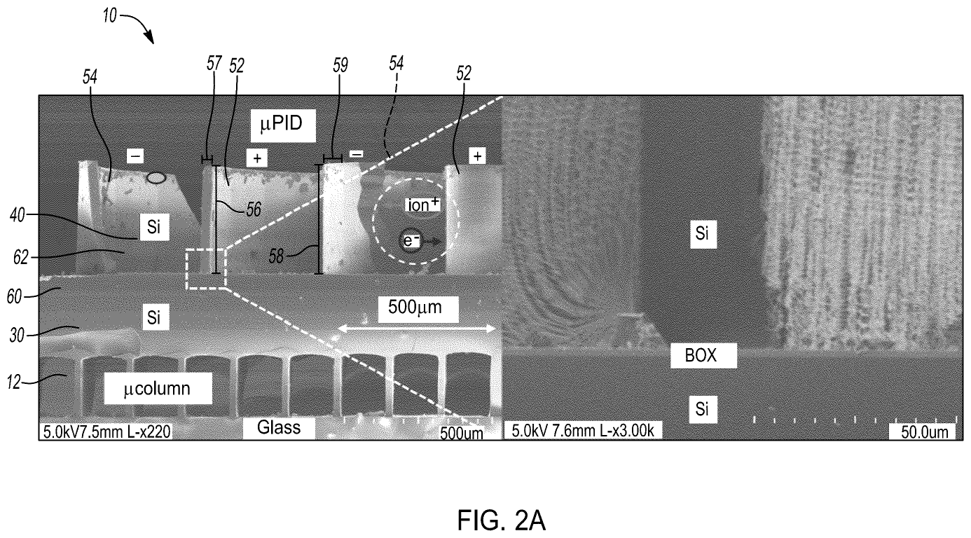

The gas detector 14 includes a pair of electrodes 50 configured to apply a voltage across the pair of electrodes 50. The pair of electrodes 50 are arranged proximate to the ionization chamber 40. As best shown in FIGS. 2A-2B, the pair of electrodes 50 are parallel-plate electrodes including a positive electrode 52 that is spaced apart from a negative electrode 54. Each of the positive electrode 52 and the negative electrode 54 extend substantially perpendicular to a surface of the second layer 32. A height 56 of the positive electrode 52 is larger than a width 57 of the positive electrode 52. Similarly, a height 58 of the negative electrode 54 is larger than a width 59 of the negative electrode 54. The ionization chamber 40 is positioned between the positive electrode 52 and the negative electrode 54 (i.e., the positive electrode 52 and the negative electrode 54 are arranged proximate to opposing sides of the ionization chamber 40). In these example embodiments, the ionization chamber 40 is arranged in a spiral, however, other shapes, spacing, and arrangement of the ionization chamber 40 and/or pair of electrodes 50 are possible. It can be appreciated that parallel-plate electrodes may provide a stronger and more uniform electric current (e.g., voltage) between the positive electrode 52 and the negative electrode 54 as compared to electrodes having other configurations (e.g., coplanar electrodes).

With renewed reference to FIGS. 1A-1C, the monolithic gas chromatograph 10 further includes a third layer 60 disposed between the first layer 30 and the second layer 32. The third layer 60 is configured to electrically isolate the first layer 30 and the second layer 32. In these example embodiments, the first layer 30 and the second layer 32 are semiconductors (e.g., silicon and/or germanium). The third layer 60 is an insulator. Specifically, the third layer 60 comprises a buried oxide (BOX), such as silicon dioxide. In combination, the first layer 30, second layer 32, and third layer 60 form a silicon on insulator (SOI) wafer.

The separation column 12 is fluidly connected to the gas detector 14 by one or more channels or vias (e.g., fluidic vias) in the third layer 60. In these example embodiments, a first via 70 extends through the third layer 60. The first via 70 is in fluid communication with the first intermediate port 23 of the separation column 12 and the inlet 24 of the gas detector 14 (i.e., fluidly connecting the separation column 12 and the gas detector 14). A second via 72 (FIG. 1C) may extend through the third layer 60 to fluidly connect the outlet 26 (FIG. 1A) of the gas detector 14 and the second intermediate port 27 of the separation column 12. In this way, while the separation column 12 in the first layer 30 and the gas detector Substitute Specification (Clean Copy) 14 in the second layer 32 are electrically isolated, the separation column 12 and the gas detector 14 are fluidly connected.

One or more wedges 74 may be disposed in the first via 70 and/or the second via 72 (e.g., at the inlet 24 and/or outlet 26 of the gas detector 14). The wedges 74 may prevent exposure to contamination during manufacture of the monolithic gas chromatograph 10. For example, the wedges 74 may prevent epoxy from entering the first via 70 and/or the second via 72 when the VUV light is sealed to the gas detector 14.

The heater 22 is configured to heat the gas sample received in the separation column 12. In the example embodiments of FIGS. 1A-1C, the heater 22 is embedded in the integrated chip 16. The heater 22 is positioned proximate to a second layer 32 of the integrated chip 16. In this way, as best shown in FIG. 1C, the separation column 12 and substrate 31 are positioned on a first side 64 (e.g., a front side) of the integrated chip 16 and the heater 22 and gas detector 14 are positioned on an opposite second side 66 (e.g., a back side) of the integrated chip 16.

In some embodiments, the monolithic gas chromatograph 10 further includes a fourth layer 62 (FIG. 1B) positioned between the second layer 32 and the heater 22 to electrically isolate the heater 22 and the gas detector 14. The fourth layer 62 is an insulator (e.g., a silicon dioxide).

In these example embodiments the configuration of the separation column 12 and gas detector 14 on the integrated chip 16 reduces the overall size of the monolithic gas detector 10. Because the separation column 12 and gas detector 14 are fluidly connected, further upstream and/or downstream analyses of the gas sample are enabled. In one example, the separation column 12 is connected to sampling loop (not shown) on the integrated chip 16 such that the gas sample flows through the sampling loop before being received in the inlet 18 of the separation column 12. It is also contemplated that the outlet 26 of the gas detector 14 and/or the outlet 28 of the separation column 12 are connected to a second column (not shown) on a second integrated chip. Additionally or alternately, the outlet 26 of the gas detector 14 and/or the outlet 28 of the separation column 12 may be fluidly connected to an inlet of a second gas detector (not shown).

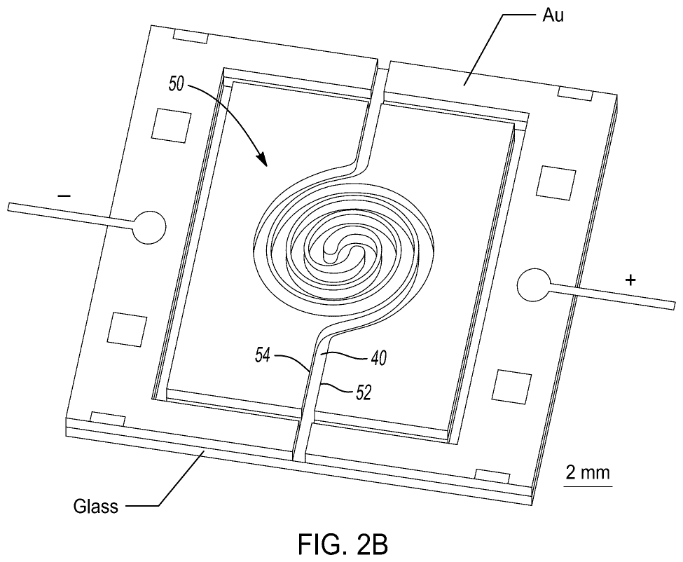

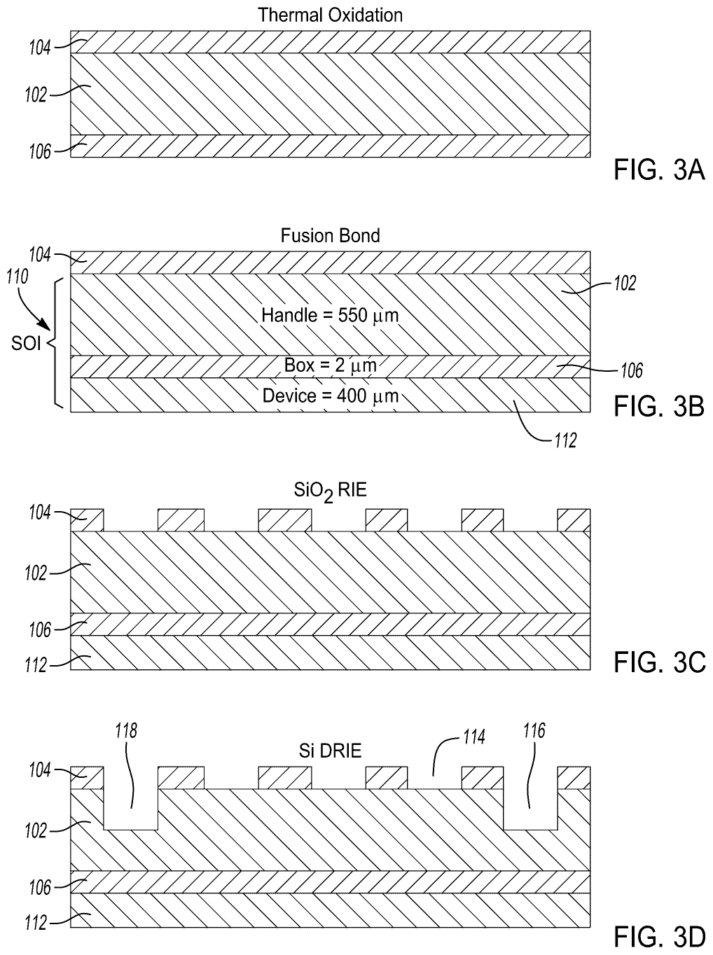

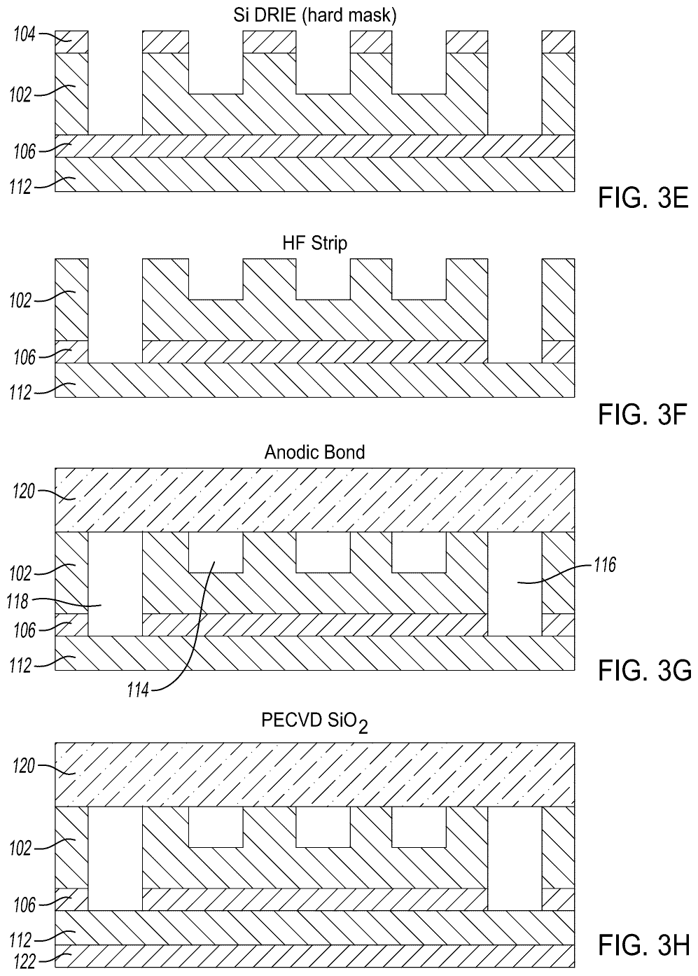

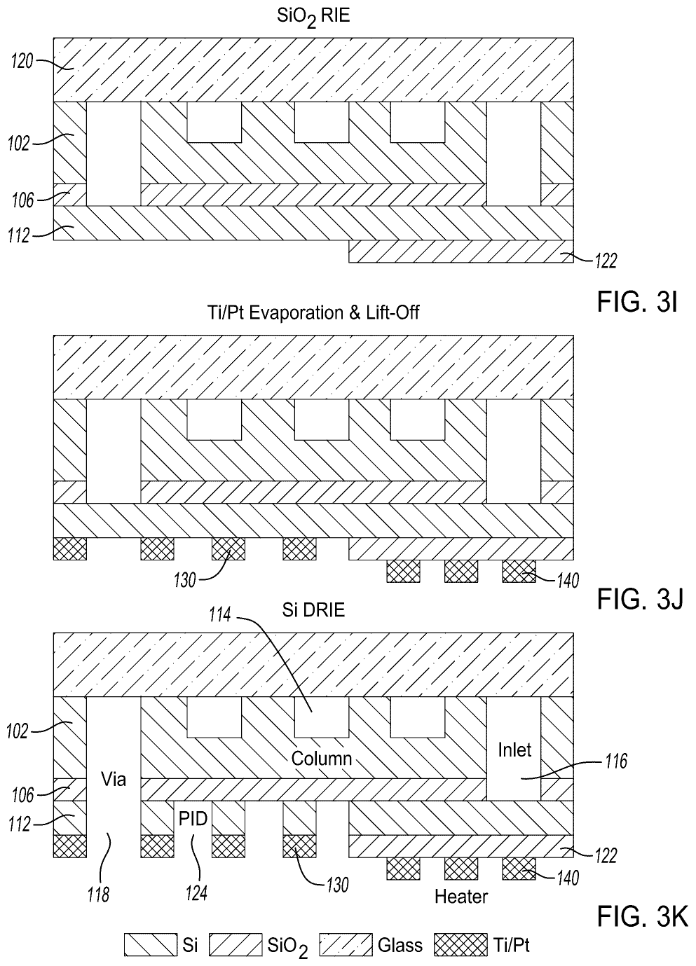

For proof of concept, a monolithic gas chromatograph in accordance with the present disclosure was fabricated and tested. FIG. 3 depicts a method of fabricating a monolithic gas chromatograph.

In FIG. 3A, a semiconductor wafer (e.g., a silicon wafer) was obtained to form a first layer 102. The semiconductor wafer was a 400 micrometer (μm) thick, double-side polished silicon wafer (<100>, p-type, 1-10 Ω*cm). The first layer 102 includes a first oxide layer 104 and a second oxide layer 106 (having a 2 μm thickness) disposed on opposite surfaces. The first layer 102 was cleaned (e.g., RCA cleaned). Then, the first layer 102 was treated with a dielectric barrier discharge (DBD) of atmospheric N₂ plasma treatment.

In FIG. 3B, a SOI wafer 110 was formed. The SOI wafer 110 includes the first layer 102, a second layer 112, and the second oxide layer 106 disposed between the first layer 102 and the second layer 112. The second layer 112 was formed with a 400 micrometer (μm) thick, double-side polished silicon wafer (<100>, p-type, 0.001-0.005 Ω*cm). The silicon wafer was cleaned and treated like the silicon wafer of the first layer 102. The second layer was bonded (e.g., fusion bonded) to the first layer 102 under vacuum at 400° C. and 20 MPa for 4 hours. It is contemplated that alternative microfabrication processes that produce SOI wafers with BOX, such as separation by implantation of oxygen (SIMOX), can also be used.

In FIG. 3C-3G, a separation column 114 including an inlet 116, an outlet (not shown) (hereafter the “inlets 116”), and one or more channels or vias 118 were formed in the first layer 102. In FIG. 3C, a pattern was etched (e.g., via photolithography and reactive ion etching (RIE)) in the first layer 102 and the first oxide layer 104. The separation column 114 had a length of 3 meters (m), width of 150 μm, and depth of 30 μm (e.g., the walls of the column had a 30 μm height). The inlets 116 had a width of 400 μm. The vias 118 had a width (i.e., a diameter) of 550 μm. Photolithography was used to selectively expose the inlets and vias for a deep reactive-ion etching (DRIE) etch of about 150 μm in depth (FIG. 3D). The photoresist was then stripped and DRIE continued with a hard mask to simultaneously etch the separation column 114 to a final depth of 250 μm while the inlets 116 and the vias 118 were etched to the second oxide layer 106 with a depth of 400 μm (FIG. 3E). In FIG. 3F, the first oxide layer 104 and portions of the second oxide layer 106 proximate to the inlets 116 and/or vias 118 were removed. The first oxide layer 104 and portions of the second oxide layer 106 were stripped with hydrogen fluoride (HF). In FIG. 3G, a substrate 120 was bonded to the first layer 102. The substrate 120 was a 550 μm thick Borofloat 33 glass. The glass substrate 120 was piranha-cleaned. Then, the glass substrate 120 was anodically bonded to the first layer 102, sealing the separation column 114.

In FIG. 3H, a third oxide layer 122 on the second layer 112 was formed on the second layer 112 (e.g., on a surface opposite the second oxide layer 106). 1 μm of silicon dioxide was deposited on the second layer 112 by plasma-enhanced chemical vapor deposition (PECVD).

In FIG. 3I, a portion of the third oxide layer 122 was removed to define a position of a gas detector 124. The position of the gas detector 124 was defined by photolithography and RIE.

In FIG. 3J, electrodes 130 and a heater 140 were formed on the second layer 112. A layer of Ti/Pt (30/360 nm) was patterned on the second layer 112 using lithography, evaporation, and liftoff to form the electrodes 130 and heater 140 simultaneously.

In FIG. 3K, an ionization chamber 152 of the gas detector 124 was formed in the second layer 112 by photolithography, RIE, and DIE processes. The electrodes 130 were formed into 400 μm wide channels in an Archimedean spiral. The channels had a depth of 40 μm (i.e., walls defining the ionization chamber 152 had a height of 40 μm). The ionization chamber 152 was etched to the second oxide layer 106.

The insulated wedges (see, e.g., wedges 74 of FIG. 1C) were microfabricated using a 400 μm thick, double-side polished silicon wafer that was first diced into 2 cm by 2 cm pieces. Then the pieces were patterned and etched through to generate the free-standing wedges. The wedges were then conformally coated with 500 nm of SiO₂ by atomic layer deposition (ALD) for insulation. It should be noted that the ALD process was chosen for its ability to achieve the best conformal coating along the sidewall, although sputtering was also used to achieve the same purpose.

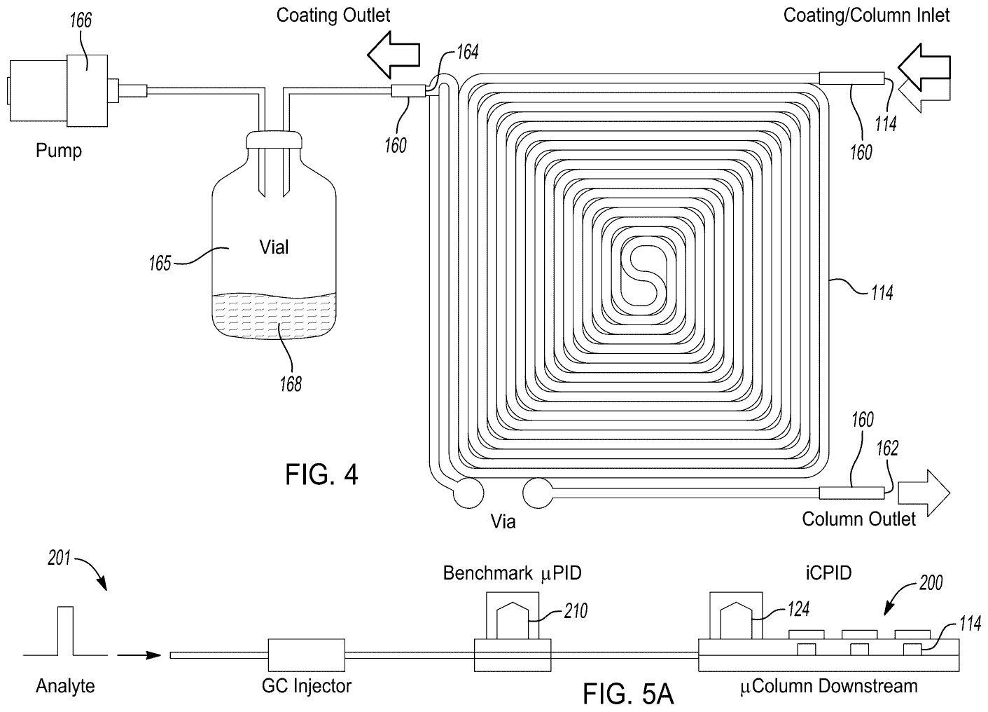

Next, as shown in FIG. 4, the separation column 114 was coated. First, guard columns 160 were inserted into the inlet 116 and outlet 162 of the separation column 114 as well as the coating outlet port 164. Prior to coating, the separation column 114 was deactivated by eight repeated injections of hexamethyldisilazane (HMDS) into the inlet 116 at 120° C. within 1 hour, and the coating outlet 162 was blocked with a rubber septum during deactivation. Next, the coating outlet 162 was hermetically connected to a vial 165 that was linked to a pump 166. A coating solution 168 (2% (w/w) of 0V-5 in dichloromethane) of 100 μL was then injected from the inlet 116 and dynamically coated into the 3 m μcolumn. The pump's pulling mechanism ensures the coating solution 168 to bypass the gas detector 124 downstream. The coating rate was controlled by adjusting the voltage of the pump 166, which was set at 5 cm/min. The coating process was repeated 3 times. The separation column 114 was subsequently treated with HMDS after each coating and then baked at 180° C. for 1 hour prior to use. The coating solution 168 was then drained into the vial 165 and could be recycled for further usage. Finally, the guard column 160 attached to the coating outlet 162 was removed, and UV epoxy was applied to block the outlet.

After the separation column 114 coating, the monolithic gas chromatograph was affixed to a printed circuit board (PCB), and the integrated gas detector 124 and heater 140 were wire-bonded. The heater had a resistance of 50 Ohms. Next, the insulated wedges (see, e.g., wedges 74 of FIG. 1C) were fitted into the designated slots in front of the microfluidic vias 118.

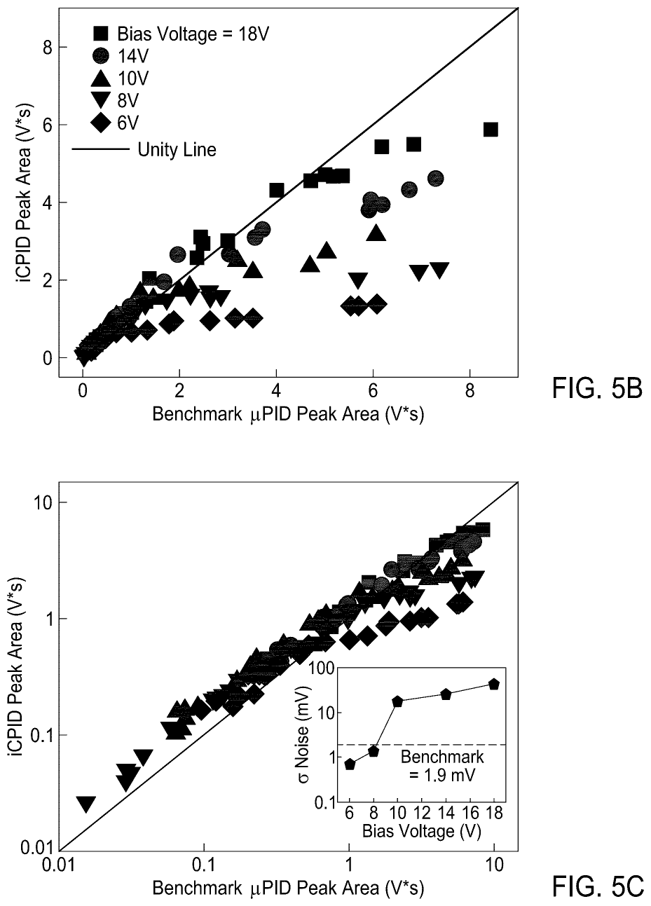

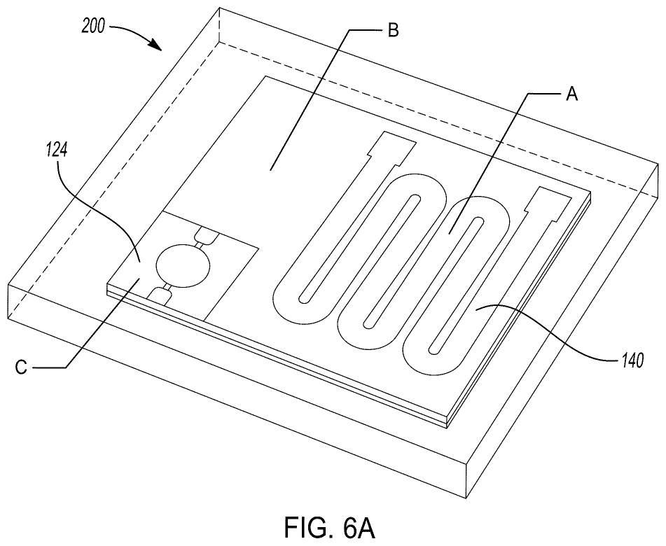

Finally, a VUV lamp was bonded to the second layer 112, thus forming a monolithic gas chromatograph 200 (FIG. 5A). A 10.6 eV VUV Kr lamp with a MgF₂ window. The VUV lamp was hermetically secured to the second layer 112 using a UV curable epoxy (NOA 68T).

The monolithic gas chromatograph 200 was operated using a system platform controlled by LabVIEW™ software developed in-house. A Keithley 2400 sourcemeter was used for alternating the bias voltage between the electrodes 130 of the gas detector 124. The sensitivity evaluation was performed using an Agilent 6890 benchtop gas chromatography equipped with a thermal injector operated at 250° C. and in a split mode for controlling analyte injection amount. 99.999% Helium was used as the carrier gas with a flow rate of 3 mL/min. All measurements were done at room temperature with only guard columns for fluidic connections. The heater 140 on monolithic gas chromatograph 200 was driven by 5-Hz pulse-width-modulation (PWM) driven by the NI DAQ card. A thermocouple was used to access the temperature measurement.

FIG. 5A depicts an experimental setup 201 for the monolithic gas chromatograph 200. As described above, the monolithic gas chromatograph 200 includes the separation column 114 and the gas detector 124 on an integrated chip. A stand-alone gas detector 210 (hereafter, the “benchmark gas detector 210”) was used as a benchmark to evaluate the sensitivity of the gas detector 124 of the monolithic gas chromatograph 200. The benchmark gas detector 210 had a single-digit picogram detection limit with approximately six orders of magnitude linear dynamic range up to 1000 ng. To ensure an accurate comparison, the monolithic gas chromatograph 200 was fluidly connected to the benchmark gas detector 210 in series after the benchmark gas detector 210. The gas sample (e.g., analytes), flowed through the benchmark gas detector 210 and then through the monolithic gas chromatograph 200. FIGS. 5B and 5C show the response of the gas detector 124 of the monolithic gas chromatograph 200 as compared to the response of the benchmark gas detector 210 at varied operating voltage (e.g., 6V-10V). FIG. 5B shows the linear peak area of gas detector 124 as a function of the peak area of the benchmark gas detector 210. FIG. 5C shows the log-log plot peak are of gas detector 124 as a function of peak area of the benchmark gas detector 210.

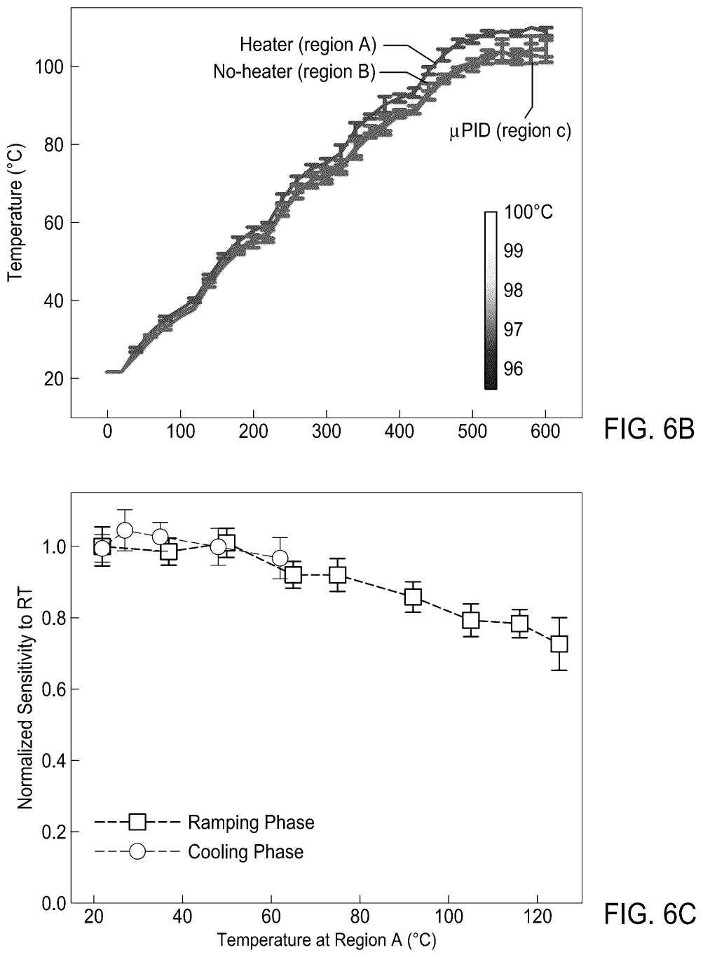

FIG. 6A depicts a schematic of the monolithic gas chromatograph 200 showing a first region A, a second region B, and a third region C. First region A includes a portion of the separation column 114 having the heater 140 embedded in an opposite surface. In this example embodiment, the heater 140 comprises about two-thirds of the surface of the integrated chip. Second region B includes a portion of the separation column 114 that is free of the heater 240 on the opposite surface. Third region C includes the gas detector 124.

The temperatures of first region A, second region B, and third region C were simultaneously measured during a temperature ramping period of the heater 140. FIG. 6B shows the temperature of first region A (black line), second region B (red line), and third region C (blue line), respectively. Both the measured and simulated temperature profiles indicate that the temperature at second region B and third region C increases almost the same as first region A during the temperature ramping period. The difference is only a few ° C., suggesting that the second region B of separation column 114 without the heater 140 may be adequately heated for efficient separation, but at the cost of inevitable thermal crosstalk to the monolithically integrated gas detector 124.

FIG. 6C shows the sensitivity of the gas detector 124 compared to the benchmark gas detector 210. The sensitivity of the gas detector 124 remained relatively stable during the initial ramp phase (>92% up to 75° C.), before gradually decreasing to ˜75% at 125° C. The sensitivity reduction was reversible (i.e., the sensitivity of gas detector 124 returned to the normal level when the temperature returned to room temperature). The reduction in sensitivity at high temperatures can primarily be attributed to changes in the VUV light photoionization source, including transmission and generation. First, the VUV light window's short-wavelength transmittance limit (116 nm or 10.6 eV for MgF₂ in this case) red-shifts as it is heated resulting in lower transmission for high-energy VUV photons. Second, VUV photon generation from plasma is an isometric process inside the VUV light housing. The temperature increase causes a higher pressure (per ideal gas law), resulting in more collisions and hence more de-excitation of the particles capable of emitting VUV photons.

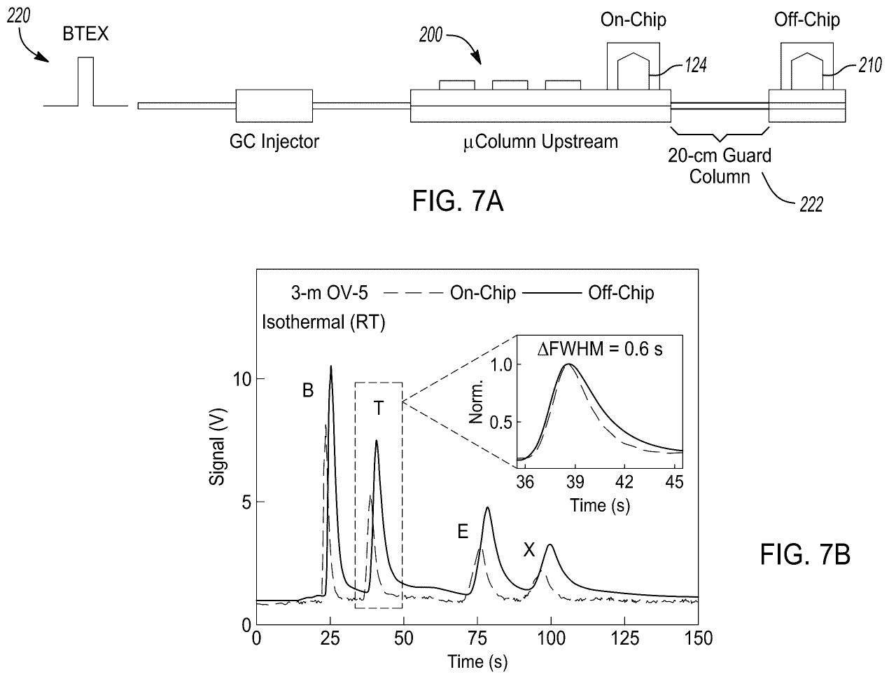

FIG. 7A depicts another experimental setup 220 for the monolithic gas chromatograph 200. To compare peak shape difference between the gas detector 124 of the monolithic gas chromatograph 200 and the benchmark gas detector 210, the benchmark gas detector 210 was connected to an outlet of the gas detector 124 via a 20-cm guard column 222. A BTEX mixture (i.e., benzene, toluene, ethylbenzene, and p-xylene) was selected the model analytes. The monolithic gas chromatograph 200 was operated isothermally at room temperature (i.e., without temperature ramp of heater 140) to simulate a field operation scheme with low power consumption.

FIG. 7B shows analyte peaks of the gas detector 124 (red line) as compared to the benchmark gas detector 210 (black line). The gas detector 124 detected that the BTEX analytes were effectively separated by separation column 114 with height equivalents to theoretical plate (HETP) values of 3.5 mm (benzene), 3.0 mm (toluene), 2.6 mm (ethylbenzene), and 2.4 mm (p-xylene). The benchmark gas detector 210 detected a similar chromatogram with broader peak widths for each peak. For example, the inset of FIG. 7B shows that the gas detector 124 detection rendered a toluene peak 0.6 seconds narrower in full-width-half-maximum (FWHM) than the benchmark gas detector 210 detection.

The corresponding differences for benzene, ethylbenzene, and p-xylene are 0.7 seconds, 1 seconds, and 0.5 seconds, respectively. The peak broadening effect can be attributed to the interconnecting guard column 222 between the gas detector 124 and the benchmark gas detector 210. These results manifest the advantage of monolithic integration of separation column 114 and gas detector 124 by eliminating transfer lines in between, which further becomes cold spots when temperature is ramped.

The peak of gas detector 124 was also compared to the peak of a commercial column and gas detection system at room temperature. The HETP values of benzene (35.4 mm) and toluene (7.4 mm) in the commercial column were found to be significantly larger than those of gas detector 124 due to broader peak widths in commercial columns. Additional full-width-half-maximum (FWHM) of 4 seconds and 3.4 seconds were observed for benzene and toluene peaks, respectively. However, the HETP values of ethylbenzene (2.2 mm) and p-xylene (1.8 mm) were similar to those in the gas detector 124 as their respective retention times in the commercial column were much longer. Both the broader peak widths in the early two peaks and longer retention times in the latter two can be attributed to a thicker coating of the commercial column (0.25 μm) than the coating of the separation column 114 of the monolithic gas chromatograph 200 (˜0.1 μm).

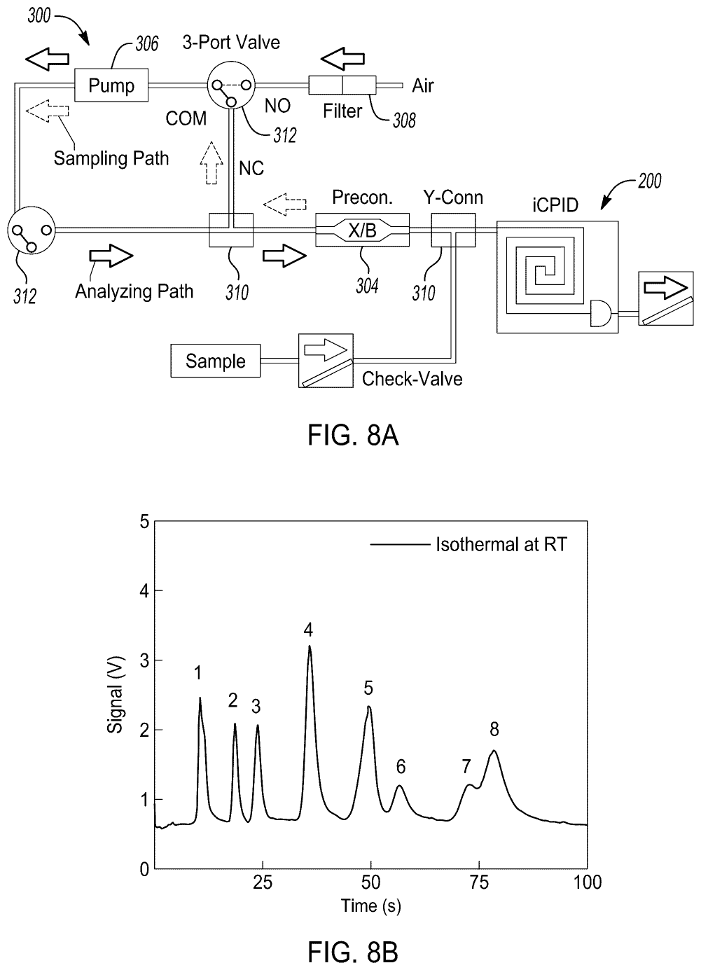

FIGS. 8A-8C show a gas chromatograph system 300 (hereafter the “integrated system 300”) including the monolithic gas chromatograph 200. FIG. 8A shows a fluid flow path of a gas sample 301 during operation of the integrated system 300. The integrated system 300 may include a box or enclosure. The integrated system 300 further includes a stainless-steel pre-concentrator 304, the monolithic gas chromatograph 200, a pump 306, an air filter 308, two microfabricated Y-connectors 310, two 3-port valves 312, a set of four 5500 mAh Substitute Specification (Clean Copy) rechargeable batteries 314 and an in-house control circuit board 316. Components were fluidically interconnected using flexible Polytetrafluoroethylene (PTFE) tubes and guard columns. A bias voltage for the monolithic gas chromatograph 200 was set to 6 V to optimize the signal to noise ratio of the integrated system 300. To further minimize the noise, copper mesh shields were used inside the enclosure 302 to cover the monolithic gas chromatograph 200 and major EMI-prone electrical components.

During operation of the integrated system 300, the analytes were sampled from a gas storage bag into the pre-concentrator 304 before backflush injection into the monolithic gas chromatograph 200 (the red analyzing path). Ambient air, which was filtered through an inline filter to remove moisture and hydrocarbons, was used as the carrier gas at a flow rate of ˜0.9 mL/min. Separation was conducted isothermally at room temperature (˜22° C.). FIG. 8B shows a representative chromatogram of a standard sample containing VOCs (acetone at (1), benzene at (2), heptane at (3), toluene at (4), octane at (5), butyl acetate at (6), ethylbenzene at (7), and xylene at (8)). Separation of the gas sample 301 can be completed within 100 seconds.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A monolithic gas chromatograph, comprising:
a separation column having an inlet to receive a gas sample therein, wherein the separation column resides in a first layer of an integrated chip;
a gas detector having an ionization chamber and an ionization source, wherein the ionization chamber has an inlet in fluid communication with an intermediate port of the separation column to receive the gas sample therefrom, the ionization source is configured to ionize molecules of the gas sample residing in the ionization chamber, the gas detector resides in a second layer of the integrated chip, and the gas detector is fluidically coupled to the separation column; and
a third layer disposed between the first layer and the second layer and configured to electrically isolate the first layer from the second layer.

2. The monolithic gas chromatograph of claim 1 wherein the ionization source is further defined as a vacuum UV light source.

3. The monolithic gas chromatograph of claim 1 wherein the separation column is fluidically coupled to the gas detector via a fluidic via in the third layer.

4. The monolithic gas chromatograph of claim 1 further comprises a heater integrated in the integrated chip and disposed proximate to the second layer.

5. The monolithic gas chromatograph of claim 1 wherein the first layer and the second layer are comprised of silicon and the third layer is comprised of silicon dioxide.

6. The monolithic gas chromatograph of claim 1 wherein the gas detector further includes a pair of electrodes arranged proximate to the ionization chamber and configured to apply a voltage across the pair of electrodes.

7. The monolithic gas chromatograph of claim 6 wherein the pair of electrodes are parallel-plate electrodes including a positive electrode spaced apart from a negative electrode, each of the positive electrode and the negative electrode extend perpendicular to a surface of the second layer and have a height that is larger than a width.

8. The monolithic gas chromatograph of claim 7 wherein the ionization chamber is positioned between the positive electrode and the negative electrode.

9. The monolithic gas chromatograph of claim 8 wherein the ionization chamber is arranged in a spiral.

10. The monolithic gas chromatograph of claim 1, wherein the ionization source is selected from the group consisting of: vacuum ultraviolet (UV) light, plasma, flame, radioactive materials, high-voltage discharge, and high-energy electrons.

11. A monolithic gas chromatograph, comprising:
a separation column having an inlet to receive a gas sample therein, wherein the separation column resides in a first layer of an integrated chip; and
a gas detector having an ionization chamber and a vacuum UV light source, wherein the ionization chamber has an inlet in fluid communication with an intermediate port of the separation column to receive the gas sample therefrom, the vacuum UV light source is configured to ionize molecules of the gas sample residing in the ionization chamber, and the gas detector resides in a second layer of the integrated chip.

12. The monolithic gas chromatograph of claim 11 further comprising a third layer disposed between the first layer and the second layer, wherein the third layer is configured to electrically isolate the first layer from the second layer.

13. The monolithic gas chromatograph of claim 12 wherein the separation column is fluidically coupled to the gas detector via a fluidic via in the third layer.

14. The monolithic gas chromatograph of claim 12 wherein the first layer and the second layer are comprised of silicon and the third layer is comprised of silicon dioxide.

15. The monolithic gas chromatograph of claim 11 further comprises a heater integrated in the integrated chip and disposed proximate to the second layer.

16. The monolithic gas chromatograph of claim 11 wherein the gas detector further includes a pair of electrodes arranged proximate to the ionization chamber and configured to apply a voltage across the pair of electrodes.

17. The monolithic gas chromatograph of claim 16 wherein the pair of electrodes are parallel-plate electrodes including a positive electrode spaced apart from a negative electrode, each of the positive electrode and the negative electrode extend perpendicular to a surface of the second layer and have a height that is larger than a width.

18. The monolithic gas chromatograph of claim 17 wherein the ionization chamber is positioned between the positive electrode and the negative electrode.

19. The monolithic gas chromatograph of claim 18 wherein the ionization chamber is arranged in a spiral.

20. A monolithic gas chromatograph, comprising:
a separation column having an inlet to receive a gas sample therein, wherein the separation column resides in a first layer of an integrated chip;
a gas detector having an ionization chamber, a vacuum UV light source, and a pair of electrodes, wherein the ionization chamber has an inlet in fluid communication with an intermediate port of the separation column to receive the gas sample therefrom, the vacuum UV light source is configured to ionize molecules of the gas sample residing in the ionization chamber, the pair of electrodes are arranged proximate to the ionization chamber and configured to apply a voltage across the pair of electrodes, and the gas detector resides in a second layer of the integrated chip; and
a third layer disposed between the first layer and the second layer and configured to electrically isolate the first layer from the second layer, wherein the separation column is fluidically coupled to the gas detector via a fluidic via in the third layer.
